(19) United States
(12) Patent Application Publication
(10) Pub. No.: US 2009/0249375 A1
(43) Pub. Date: Oct. 1, 2009

(54) STORED OBJECT DETECTING DEVICE

(76) Inventor: Yuichi Itamoto, Tokyo (JP)

Correspondence Address: NEC CORPORATION OF AMERICA, 6535 N. STATE HWY 161, IRVING, TX, 75039, US

(21) Appl. No.: 12/410,651

(22) Filed: Mar. 25, 2009

(30) Foreign Application Priority Data
Mar. 26, 2008 (JP) 2008-079504

(51) Int. Cl. G11B 17/04

(52) U.S. Cl. 720/601; G9B/17.013

(57) ABSTRACT

A stored object detecting device includes a transferring device and a detecting device. The transferring device fetches a first object from a storage cell and moves parallel to a first direction with the first object being held in a holding portion of the transferring device. The detecting device detects a second object stored in the storage cell. The detecting device is mounted to the transferring device such that the detecting device is offset parallel to the first direction from the transferring device.

### INCORPORATION BY REFERENCE

This application is based upon and claims the benefit of priority from Japanese patent application No. 2008-079504, filed on Mar. 26, 2008, the disclosure of which is incorporated herein in its entirely by reference.

### TECHNICAL FIELD

The present invention relates to a device and a method for detecting a stored object, and more particularly to a device and a method for detecting a data cartridge such as magnetic tape, magnetic disk, optical disk, and magneto-optical disk stored in a library device.

### BACKGROUND ART

There has been known a library device in which data cartridges are stored in a plurality of cells. The library device may be referred to as a data storage system. FIG. 1 is an external perspective view of a library device disclosed in Japanese Laid Open Patent Application (JP-P2005-209278A).

As illustrated in FIG. 1, the library device includes magazines 200a, 200b, 200c and 200d, data cartridge drives 600, and an accessor mechanism 400. Each magazine includes a plurality of cells 300 for storing data cartridges 100 with the data cartridges 100 being stacked in a horizontal posture. Each of the magazines 200a, 200b, 200c and 200d includes sets of stacked cells 300. The stacked cells 300 are stacked in Z direction. The sets of stacked cells 300 are arranged in X direction. The data cartridge drivers 600 read data from and write data to recording media in the data cartridges 100. The accessor mechanism 400 transfers the data cartridge 100 from the cell 300 to the data cartridge drive 600 and from the data cartridge drive 600 to the cell 300. The magazines 200a to 200d are arranged such that opening portions of the cells 300 of the magazines 200a and 200b faces along Y direction to opening portions of the cells 300 of the magazines 200c and 200d. The accessor mechanism 400 is provided with a swivel mechanism for rotating a picker mechanism 500. The picker mechanism 500 enters and pulls the data cartridge 100 in and from the cell 300. The picker mechanism 500 enters and pulls the data cartridge 100 in and from the data cartridge drive 600.

As shown in FIG. 2, the picker mechanism 500 includes a picker frame 510 and a feeding portion 520. The feeding portion 520 moves forward and backward along Y direction to enter and pull the data cartridge 100 in and from the cell 300. The feeding portion 520 includes a picker arm 521 which engages a notch 110 of the data cartridge 100.

According to the structure of the library device, a large number of data cartridges 100 can be stored in a small space. In the library device, each cell 300 can store a data cartridge 100 and cannot store two or more data cartridges 100.

### SUMMARY

An exemplary object of the present invention is to provide a stored object detecting device and a stored object detecting method for detecting a stored object in a short time.

A stored object detecting device according to an exemplary aspect of the invention includes a transferring device and a detecting device. The transferring device fetches a first object from a storage cell and moves parallel to a first direction with the first object being held in a holding portion of the transferring device. The detecting device detects a second object stored in the storage cell. The detecting device is mounted to the transferring device such that the detecting device is offset parallel to the first direction from the transferring device.

A stored object detecting method according to another exemplary aspect of the invention includes a fetching step, a moving step, and a detecting step. In the fetching step, a transferring device fetches a first object from a first storage cell. In the moving step, the transferring device moves parallel to a first direction with the first object being held in a holding portion of the transferring device. In the detecting step, a detecting device detects a second object stored in the first storage cell with the first object being held in the holding portion. The detecting device is mounted to the transferring device such that the detecting device is offset parallel to the first direction from the transferring device.

According to the stored object detecting device and the stored object detecting method, the detecting device is offset parallel to the moving direction of the transferring device from the transferring device. Thus, the detecting device can detect the second object with the first object being held in the holding portion of the transferring device. Consequently, the second object can be detected in a short time.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is an external perspective view of a library device;

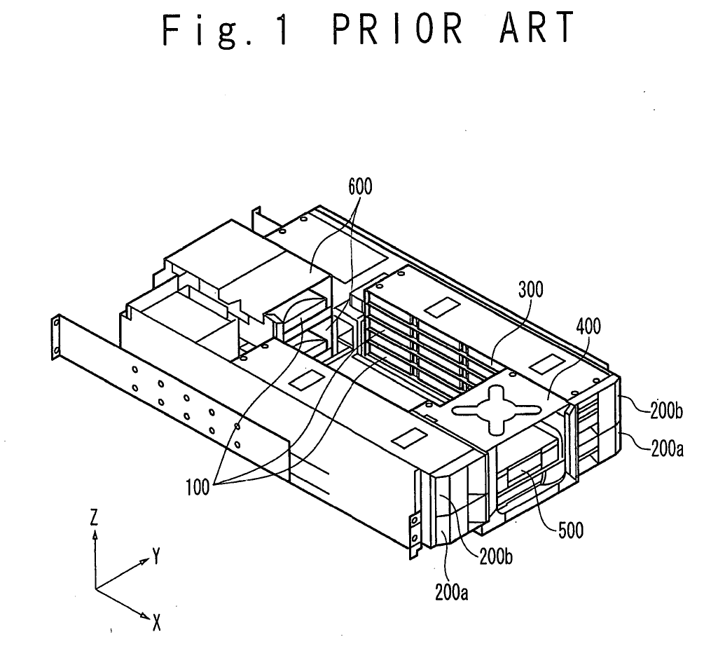

FIG. 2 is a plan view of a picker mechanism of the library device;

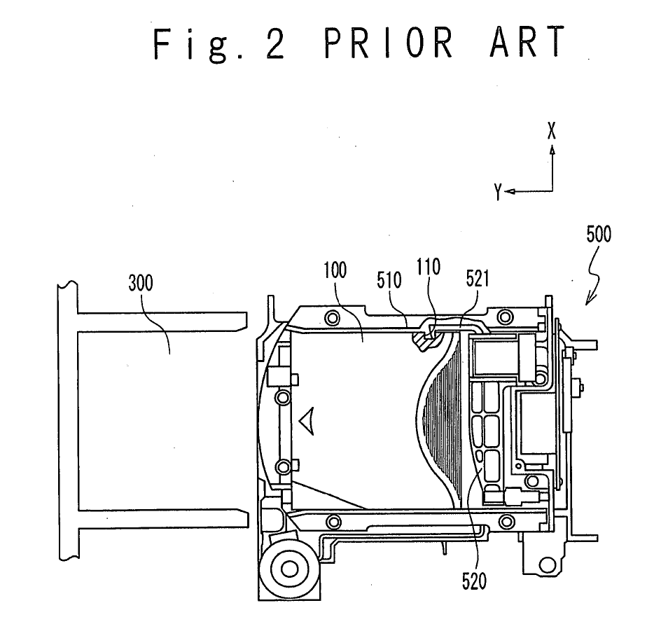

FIG. 3 is a plan view of a library device according to a first exemplary embodiment of the present invention;

FIG. 4 is a perspective view of a magazine and an accessor mechanism of the library device according to the first exemplary embodiment;

FIG. 5 is a block diagram of a detecting device of the library device according to the first exemplary embodiment of the present invention;

FIG. 6 is a perspective view of the magazine and the accessor mechanism of the library device according to the first exemplary embodiment; and

FIG. 7 is a block diagram of a detecting device of a library device according to a second exemplary embodiment of the present invention.

### EXEMPLARY EMBODIMENTS

Hereinafter, a stored object detecting device and a stored object detecting method according to exemplary embodiments of the present invention will be described with reference to the attached drawings.

### (First Exemplary Embodiment)

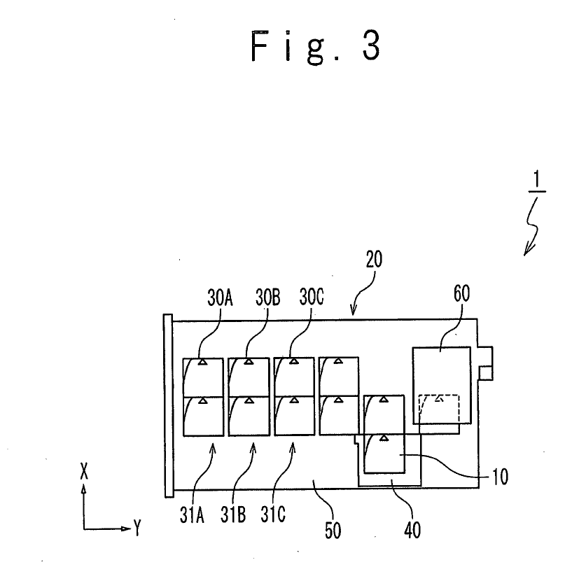

FIG. 3 is a plan view of a library device 1 as an example of a stored object detecting device according to a first exemplary embodiment of the present invention. The library device 1 includes a magazine 20, an accessor mechanism 40 as a transferring device, and a data cartridge drive 60. The magazine 20 includes storage cells 30A to 30C for storing data cartridges 10 such as magnetic tapes, magnetic disks, optical disks, and magneto-optical disks. The data cartridges 10 may be referred to as objects or stored objects. The storage cell 30B is adjacent to the storage cell 30A. The storage cell 30C is adjacent to the storage cell 30B. The storage cells 30A to 30C respectively include opening portions 31A to 31C. The opening portions 31A to 31C are respectively entrances and exits of the storage cells 30A to 30C. Thus, the data cartridge 10 enters in and exits from the storage cell through the corresponding opening portion. The opening portions 31A to 31C face a path 50. The path is parallel to X direction. The accessor mechanism moves along the path to transfer the data cartridge 10 from the magazine 20 to the data cartridge drive 60 and from the data cartridge drive 60 to the magazine 20.

An exemplary operation of the library device 1 based on a command will be described. The command designates one of the data cartridges 10. The accessor mechanism 40 fetches the designated data cartridge 10 from the magazine 20 and delivers the designated data cartridge 10 to the data cartridge drive 60. The data cartridge drive 60 reads data from or write data to recording media in the designated data cartridge 10 based on the command.

The library device 1 employs a deep cell system. Thus, each of the storage cells 30A to 30C can store a plurality of data cartridges 10 such that the plurality of data cartridges 10 are arranged along Y direction. Y direction is perpendicular to X direction. Each of the storage cells 30A to 30C stores the data cartridges 10 in a manner of first-in-last-out. According to the deep cell system, the above-described swivel mechanism is not necessary for the library device 1. Therefore, a room for installing the library device 1 can be small.

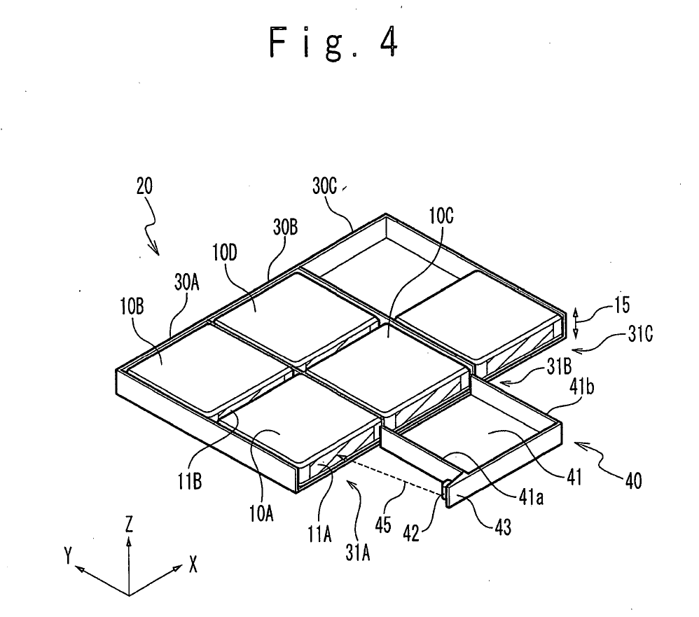

FIG. 4 is a perspective view of the magazine 20 and the accessor mechanism 40. The magazine 20 stores the data cartridges 10 in the storage cells 30A to 30C such that a thickness direction 15 of each of the data cartridges 10 is parallel to Z direction. Z direction is perpendicular to X direction and Y direction. For example, Z direction is parallel to a vertical direction. The number of data cartridges 10 stored in the storage cell 30A is two and the number of data cartridges 10 stored in the storage cell 30B is two. The number of data cartridge 10 stored in the storage cell 30C is one. Accordingly, the storage cell 30C can store another data cartridge 10.

The two data cartridges 10 stored in the storage cell 30A are data cartridges 10A and 10B. The data cartridges 10A and 10B includes barcode labels 11A and 11B, respectively. The data cartridges 10A and 10B are arranged along Y direction. The data cartridge 10A is near the opening portion 31A and the data cartridge 10B is far from the opening portion 31A.

The two data cartridges 10 stored in the storage cell 30B are data cartridges 10C and 10D. The data cartridges 10C and 10D are arranged along Y direction. The data cartridge 10C is near the opening portion 31B and the data cartridge 10D is far from the opening portion 31B.

Each of the data cartridges 10 in the storage cells 30B and 30C also includes a barcode label.

The library device 1 includes a detecting device 42 and an arm 43. The detecting device 42 is mounted to the accessor mechanism 40 via the arm 43 such that the detecting device 42 is offset parallel to X direction from the accessor mechanism 40. The accessor mechanism 40 includes a holding portion 41. For example, the detecting device 42 is mounted to a wall 41a of the holding portion 41 via the arm 43. The wall 41a is perpendicular to the X direction. The detecting device 42 is oriented in a detecting direction 45.

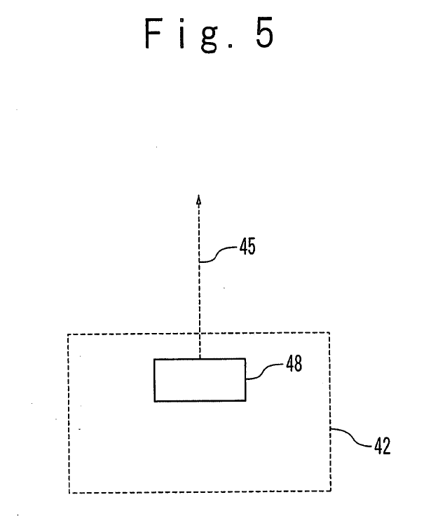

As shown in FIG. 5, the detecting device 42 includes a barcode reader 48. The barcode reader 48 outputs light to the barcode label and reads barcode based on reflected light from the barcode label. The detecting device 42 detects the corresponding data cartridge based on the success of the read of the barcode.

It is preferable that the detecting direction 45 is oblique to Y direction and perpendicular to Z direction. In this case, the wall 41a will not be an obstacle for the detection of the data cartridge 10 even when the arm 43 is short. When the arm 43 is short, the library device can be miniaturized. When oblique to Y direction, the detecting direction 45 may be referred to as an oblique direction. The detecting direction 45 can be parallel to the Y direction when the arm 43 is sufficiently long along X direction.

By the way, the detecting device 42 may be mounted to a wall 41b of the holding portion 41. The walls 41a and 41b faces in X direction each other.

A stored object detecting method according to the first exemplary embodiment will be described below. According to the stored object detecting method, the data cartridges 10B and 10D far from the opening portion 31A and 31B are detected in a short time.

With referring to FIG. 4, the detecting device 42 cannot detect the data cartridge 10B since there is the data cartridge 10A between the detecting device 42 and the data cartridge 10B. Therefore, the accessor mechanism 40 moves to a position in front of the storage cell 30A and fetches the data cartridge 10A from the storage cell 30A. When the data cartridge 10A is fetched by the accessor mechanism 40, the data cartridge 10B is moved to a position near the opening 31A.

For example, each of the storage cells 30A to 30C includes a position adjustment device (not shown). When the data cartridge 10 near the opening portion is fetched by the accessor mechanism 40, the position adjustment device moves the data cartridge 10 far from the opening portion to the position near the opening 31A. Alternatively, the accessor mechanism 40 may include a picker mechanism (not shown). When the accessor mechanism 40 fetches the data cartridge 10 near the opening portion, the picker mechanism moves the data cartridge 10 far from the opening portion to the position near the opening portion.

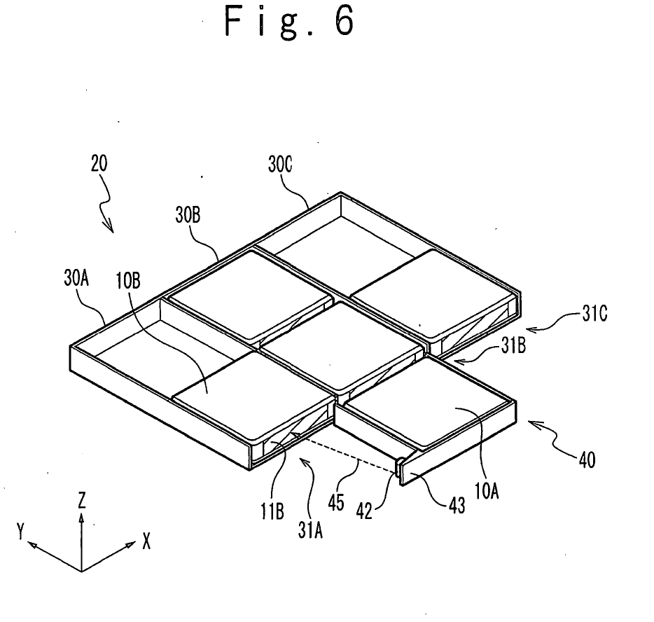

With referring to FIG. 6, after the data cartridge 10A is fetched, the accessor mechanism 40 moves parallel to X direction to a position in front of the storage cell 30B with the data cartridge 10A being held in the holding portion 41. Then, the detecting device 42 detects the data cartridge 10B stored in the storage cell 30A in the oblique direction 45 when the accessor mechanism 40 is located in front of the storage cell 30B.

After the accessor mechanism 40 returns the data cartridge 10A to the storage cell 10A, the data cartridge 10D is detected as same as in case of the data cartridge 10B.

Since the detecting device 42 is offset parallel to X direction from the accessor mechanism 40, the detecting device 42 can detect the data cartridges 10B and 10D when the data cartridges 10A and 10C are held in the holding portion 41. Therefore, the library device 1 can detect the data cartridges 10B and 10D in a short time.

On the other hand, it takes long time to detect the data cartridges 10B and 10D when the detecting device 42 is provided in the holding portion 41. In this case, the library device 1 cannot detect the data cartridges 10B and 10D without temporarily placing the data cartridges 10A and 10C in the storage cell 30C.

Furthermore, since the detecting device 42 is mounted to the accessor mechanism 4b which moves along the path 50 adjacent to the storage cells 30A to 30C, the data cartridges 10B and 10D are detected in a short time and the library device 1 occupies only a small space.

### Second Exemplary Embodiment

A stored object detecting device and a stored object detecting method according to a second exemplary embodiment and those according to the first exemplary embodiment are the same except for the detecting device 42.

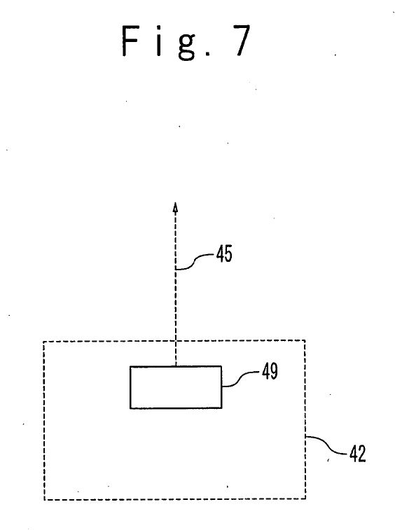

As shown in FIG. 7, the detecting device 42 according to the second exemplary embodiment includes a digital camera 49. The digital camera 49 generates digital image data of the barcode label. The detecting device 42 reads barcode based on the digital image data. The detecting device detects the corresponding data cartridge based on the success of the read of the barcode.

### Third Exemplary Embodiment

A stored object detecting device and a stored object detecting method according to a third exemplary embodiment and those according to the first exemplary embodiment are the same except for the detecting device 42.

The detecting device 42 according to the third exemplary embodiment is an optical sensor 42. The optical sensor 42 outputs light to the data cartridge 10 and detects the data cartridge 10 based on reflected light from the data cartridge 10. The barcode labels are not necessary for the optical sensor 42 to detect the data cartridges 10.

In the first to third exemplary embodiment, the magazine 20 may store the data cartridges 10 in the storage cells 30A to 30C such that the thickness direction 15 is parallel to X direction. In this case, X direction is parallel to the vertical direction.

While the invention has been particularly shown and described with reference exemplary embodiments thereof, the invention is not limited to these embodiments. It will be understood by those skilled in the art that various changes in form and details may be made therein without departing from the spirit and scope of the present invention as defined by the claims.

What is claimed is:

1. A stored object detecting device comprising:
a transferring device configured to fetch a first object from a storage cell and move parallel to a first direction with said first object being held in a holding portion of said transferring device; and
a detecting device configured to detect a second object stored in said storage cell,
wherein said detecting device is mounted to said transferring device such that said detecting device is offset parallel to said first direction from said transferring device.

2. The stored object detecting device according to claim 1, wherein said storage cell is configured to store said first object and said second object such that said first object and said second object are arranged along a second direction perpendicular to said first direction,
said detecting device is oriented in an oblique direction which is oblique to said second direction and is perpendicular to a third direction, and
said third direction is perpendicular to said first direction and said second direction.

3. The stored object detecting device according to claim 1, wherein said detecting device is an optical sensor which outputs light to said second object and detects said second object based on reflected light from said second object.

4. The stored object detecting device according to claim 1, wherein the stored object detecting device is a library device,
said storage cell is one of storage cells included in a magazine of said library device,
each of said first object and said second object is a data cartridge including a barcode label,
said transferring device is an accessor mechanism, and
said detecting device includes a barcode reader.

5. The stored object detecting device according to claim 1, wherein said storage cell stores said first object and said second object in a manner of first-in-last-out.

6. A stored object detecting method comprising:
a transferring device fetching a first object from a first storage cell;
said transferring device moving parallel to a first direction with said first object being held in a holding portion of said transferring device; and
a detecting device detecting a second object stored in said first storage cell with said first object being held in said holding portion,
wherein said detecting device is mounted to said transferring device such that said detecting device is offset parallel to said first direction from said transferring devise.

7. The stored object detecting method according to claim 6, wherein said detecting device detects said second object in an oblique direction.

8. The stored object detecting method according to claim 6, wherein said transferring device is located in front of a second storage cell adjacent to said first storage cell in said detecting device detecting said second object.
